(19) United States
(12) Patent Application Publication
(10) Pub. No.: US 2005/0015222 A1
(43) Pub. Date: Jan. 20, 2005

(54) System and method for automated building incident response

(76) Inventor: Kevin J. Harrington, Marstone Mille, MA (US)

Correspondence Address: Kathleen Chapman, Esq.;DISHONG LAW OFFICES, 40 Bryant Rd., Jaffrey, NH, 03452, US

(21) Appl. No.: 10/618,855

(22) Filed: Jul. 14, 2003

(51) Int. Cl. G06F 17/50

(52) U.S. Cl. 703/1

(57) ABSTRACT

A system and method for characterizing a building's (or building complex's) components, including all important entrances, egresses, and stairwells, collecting demographic information associated with locating people in a building, evacuating the building, and rescuing people still left in the building, etc., linking the building's components and demographic information to each other, and providing this information to authenticated users. The data can be made available through an internet connection, through a hand-held device, etc. Emergency workers and others can easily perform tasks such as directing building evacuation, dispatching other workers such as utility workers, and notifying neighbors, because the building's location, floor plan, emergency contacts, etc. are electronically interrelated.

### BACKGROUND OF THE INVENTION

The present invention relates generally to incident response when buildings are involved, and specifically to automated systems and methods for characterizing buildings for the purpose of quick access to vital data.

Concern about public safety within municipal facilities has never been greater. Security precautions such as metal detection and identification checks are in force in many previously-open buildings. Even with the additional precautions, buildings are damaged or destroyed with regularity, both due to natural and human-engineered causes. When a building (use of this term throughout this document can be interpreted to mean a single building or a complex of connected buildings) has been subject to an incident, its occupants and neighbors could be adversely affected. Usually emergency personnel arrive on the scene quickly, but must spend precious time navigating the building before actually locating occupants who might be in danger. Additionally, the building could contain or be in the vicinity of hazardous or flammable materials that could affect the surrounding neighborhood.

Currently, systems exist that can be used to scan a building and prepare a floor layout suitable for aiding in building renovation or reconstruction. Features such as the swing of the doors, sizes of windows, etc. can be discovered through the use of special scanning equipment. Details of the attributes of the building can be recorded electronically to aid in, for example, energy analysis. As useful as these systems are, they are generally limited to providing dimensional and other structural information about the rooms in the building.

There are also systems that track users within facilities and assist them in finding nearest exit routes and other locations within the building. These systems usually require externally-generated location information derived from, for example, a Global Positioning System device. Some of these systems can determine emergency egresses by accessing the electrical system in the building.

Additionally, systems exist in which a footprint of equipment within a room is created, allowing for electronic modification of the footprint to test various possible configurations. These systems are useful for positionally relating the contents of a room to each other, but are limited in that they do not relate demographic or environmental data to the contents, room, or building.

There are also systems in which information for emergency personnel is superimposed upon a building layout in which various sensors within the building are also displayed. In these systems, the computer that displays the emergency information can be in communication with the fire alarm system for the building, but the systems are limited to screen shots of the static layout of the building.

None of the present systems provides a system and method for allowing emergency personnel, utility workers, building managers, local authorities and others to quickly understand a building's and other related information, nor to perform the miriad of actions required during a building incident in a coordinated way. No system provides a portable building display containing linked structure- and incident-related information.

An object of the present invention is therefore to assist emergency personnel, utility workers, building managers, local authorities and others to quickly perform the miriad of actions required during a building incident in a coordinated way.

Another object of the present invention is to provide a portable building display containing linked structure- and incident-related information.

A further object of the present invention is to provide secure access to the characteristics and demographics of the building.

A still further object of the present invention is to provide a system and method for collecting building characteristics and their relationships that are geared to providing, with those data, incident response capability.

A yet still further object of the present invention is to provide method for collecting information about the characteristics of a building and their relationships to each other, creating metadata that interrelates the characteristics of the structure, and providing the linked characteristics electronically to receptors, including emergency personnel, utility workers, building occupants, neighbors, and local, state, and federal authorities, depending upon the incident.

### SUMMARY OF THE INVENTION

The objects set forth above as well as further and other objects are provided by the system and method of the present invention. These objects and other advantages are achieved by the illustrative embodiments of the invention described hereinbelow.

The system and method of the present invention provide important information about such buildings as, for example, public and private municipal buildings. The system and method of the present invention assist individuals in performing tasks such as, for example, collecting vital building data, creating an enhanced floor plan, and integrating photographs of important aspects of the building with these data. These data are compiled into a database of critical building information, and provided in, for example, electronic form to individuals such as, for example, emergency personnel and utility workers. If in electronic form, the building information can be easily shared, accessed from, for example, command vehicles, and updated. The building information can be provided in any form, for example, paper form.

The system of the present invention includes a linkage controller for receiving the incoming data from all sources, accessing or creating relationships among the data, and creating a new data set of linked characteristics data. These data may be stored for future access by individuals during a building incident. The system of the present invention also includes an operations controller for accessing linked characteristics data created by the linkage controller. These data contain, for example, contact information for individuals such as, for example, neighbors in the vicinity of the building, utility workers or building managers. Optionally, the system can include access control by which access to the building data is controlled automatically through pre-selected conditions. The system can also optionally include automatic contact capability such that affected individuals and authorities with relationships to the building could be supplied information about the building, such as, for example, if an incident occurs in the building, automatically through the system of the present invention.

The method of the present invention includes the steps of collecting building characteristic information and relationship information, and creating linked characteristic information using the collected characteristic information and the relationship information. This linked characteristic information allows the user to, for example, access photographs of an area of the building by pointing to a position on the building's floor plan. Important to the system's use of building incident preparation and management, the linked characteristic information allows emergency workers to be contacted and to locate rooms in the building. The method of the present invention provides the linked characteristic information to a user in a format that is useful to the user such as, for example, but not limited to, electronically or in paper format. The method could validate a user's right to access the characteristic information. Access rights could be limited, for example, to emergency workers and building managers, or change control could be limited but read access could be provided to anyone. The method could also enable contacting individuals who are associated with the building to either request their assistance or notify them of the status of the building.

For a better understanding of the present invention, reference is made to the accompanying drawings and detailed description. The scope of the present invention is pointed out in the appended claims.

### BRIEF DESCRIPTION OF THE SEVERAL VIEWS OF THE DRAWING

FIG. 1 is a schematic block diagram of the components of the system of the present invention;

FIG. 2 is a schematic block diagram of the linkage controller of the present invention;

FIG. 3 is a schematic block diagram of the operations controller of the present invention;

FIG. 4 is a flowchart of the method of the present invention; and

FIG. 5 is a screen view of a hot-linked index into the structure characteristics information and contact information collected, interrelated, formatted, and displayed through the illustrative embodiment of the present invention;

FIG. 6 is a screen view of the hot-linked contact information related to a structure through the illustrative embodiment of the present invention;

FIG. 7 is a screen view of structure characteristics related to the structure and each other through the illustrative embodiment of the present invention;

FIG. 8 is a screen view of a hot-linked floor plan of the structure related to other structure characteristics through the illustrative embodiment of the present invention; and

FIG. 9 is a screen view of photographs of the structure annotated as to location and keyed to other structure characteristics through the illustrative embodiment of the present invention.

### DETAILED DESCRIPTION OF THE INVENTION

The present invention is now described more fully hereinafter with reference to the accompanying drawings, in which the illustrative embodiment of the present invention is shown.

Before the figures are described, an example process for data collection is given to orient the reader. For example, if a building's floor plan is available, an analyst walks through building to verify the floor plan. During the walk-through, the analyst numbers each of exterior doors and photographs, perhaps digitally, the exterior door locations counterclockwise around the building, following police or command system protocol. The analyst further photographs places in the building where large numbers of people would be found. After completing the walk-through, the photographs can be labeled and changes can be made to the floor plan as noted in the walk-through. A list of relevant people and their contact information for the building can be prepared. Relevant statistics can be compiled such as, for example, the number of employees/students in the building, any motion detection system and/or closed circuit TV, and hazardous materials inside the building, science lab, or custodial rooms, and any garages within proximity of the building with hazardous materials. The directions to the building and information such as, for example, the building's utility providers and alarm system company can be compiled. All collected information is verified by, for example, a building master. For each floor of the building, the information can be pictorially reproduced, perhaps in hardcopy, and is stored electronically, perhaps on a removable medium such as a compact disk. Electronic data can be formatted properly as input to a standard program to produce a floor plan, and an electronic floor plan can be produced. This electronic floor plan can be enhanced to add window and door locations and can be copied into a word processing document in which links to other files or documents can be added. Links between building photographs, stairwells, and demographic information are created with, for example, the floor plan as a basis. The linked data can be moved to, for example, a standard handheld device, or can be made available to internet users, perhaps through secure codes.

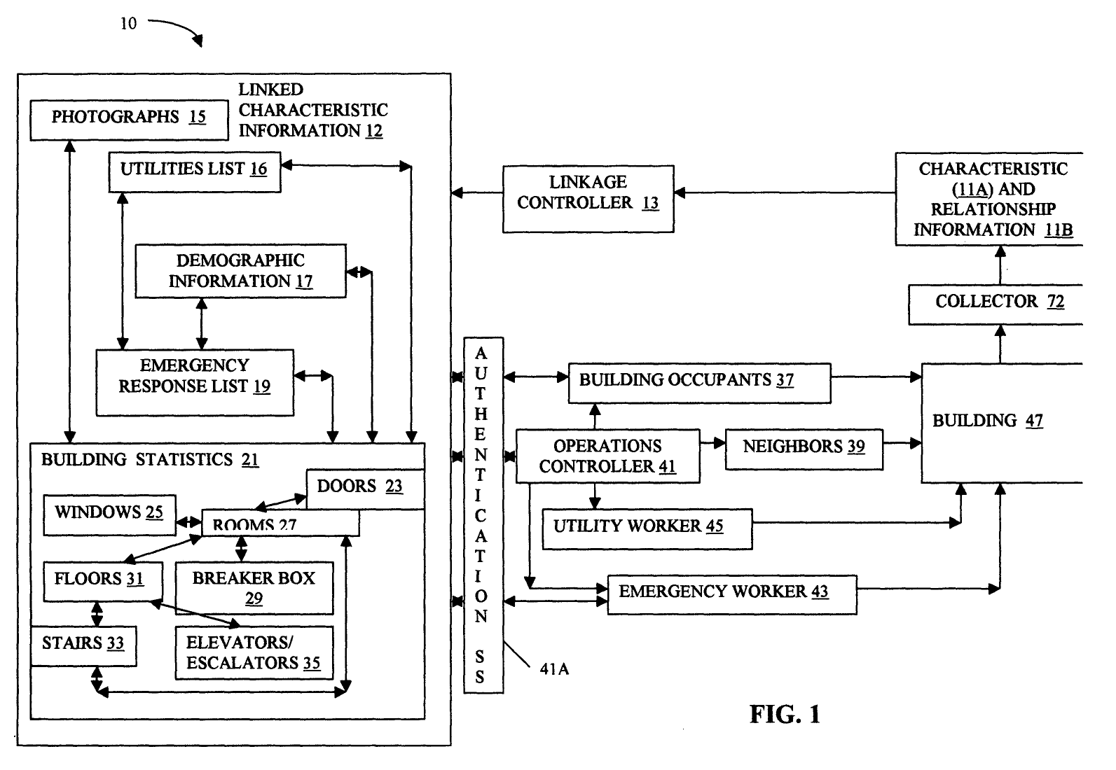

Referring now to FIG. 1, system 10 of the illustrative embodiment of the present invention implements a process such as the one outlined above. System 10 includes linkage controller 13 and operations controller 41 that interface with building 47 having building characteristic information 11A and relationship information 11B. Collector 72 provides building characteristic information 11A and relationship information 11B to linkage controller 13 which prepares linked characteristic information 12. Linkage controller 13 uses the relationship information 11B to prepare links between components of the characteristic information 11A. Characteristics can include, for example, building statistics 21 such as, for example, numbers and locations of doors 23, windows 25, rooms 27, floors 31, breaker boxes 29, stairs 31, and elevators/escalators 35, as well as photographs 15, utilities list 16, demographic information 17, and emergency response list 19. Other characteristics are not precluded by this list which is merely exemplary. Linked characteristic information 12 is provided upon request (and perhaps access authentication) for use in any number of ways. A possible requester is building occupant 37 who might want to become aware of, for example, emergency exits. Another possible requestor is utility worker 45 who might want to determine the locations of a breaker box 29 or communications connections. Yet still another possible requestor is emergency worker 43 who might need to find all doors 23 in building 47. Of great importance could be a request from operations controller 41 in case of a building incident. Operations controller 41 manages emergencies related to building 47, for example a fire, an explosion, or a terrorist attack. Operations controller 41 requests linked characteristic information 12 in order to provide the information in a coordinated way to individuals and organizations related to building 47 such as, for example, building occupants 37, neighbors 39, utility workers 45, and emergency workers 43. During a building incident, for example, individuals and organizations could be requested to respond to the incident or could be informed of the incident through operations controller 41. Building occupants 37 could be evacuated with the help of emergency workers 43 and linked characteristic information 12 provided by operations controller 41 or directly provided to requesting (and perhaps access-authenticated) building occupants 37. When emergency workers 43 arrive on the scene at the request of operations controller 41, operations controller 41 provides emergency workers 43 with linked characteristic information 12 so that they might respond appropriately to the building incident. Alternatively, emergency workers 43 and others could have continuous access to linked characteristic information 12 through internet-enabled devices.

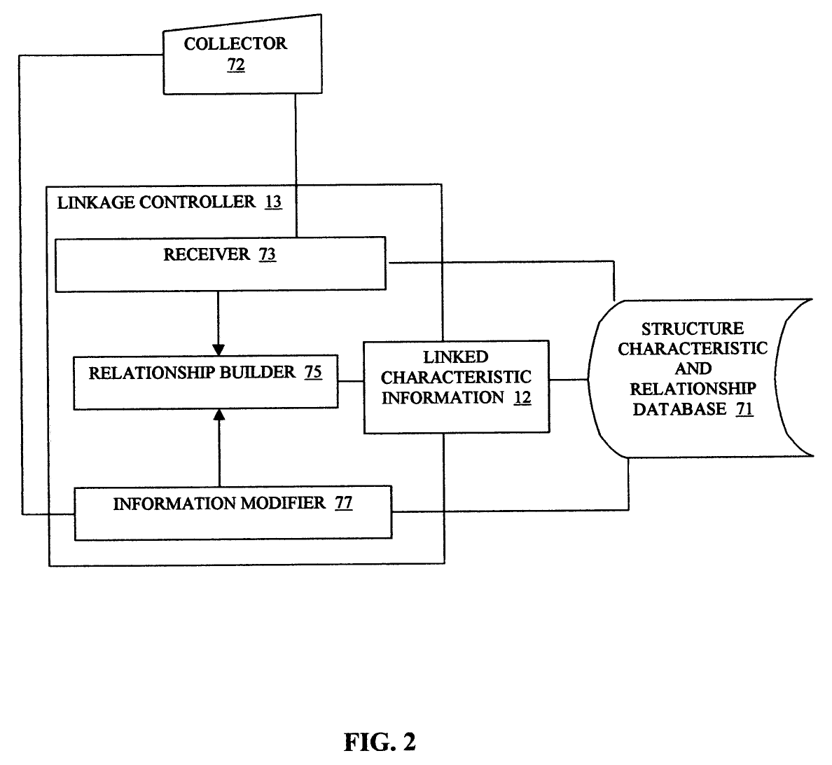

Referring now to FIG. 2, linkage controller 13 includes receiver 73 to receive data that are input to collector 72. Receiver 73 can provide any kind of interface to collector 72. For example, data could be entered into a standard computer or data could be automatically provided from, for example, a standard Global Positioning System device. Receiver 73 can be configured to accept any and all sources of information relevant to building 47 (FIG. 1) and provide it to relationship builder 75. Relationship builder 75 determines, through analysis of structure characteristic and relationship database 71 or through user input, how the various building characteristics are related to each other. For example, one possible implementation of relationship builder 75 involves moving a floor plan, for example, from a standard CAD system into a word processor such as Microsoft Word® that is capable of linking parts of one document to parts of others. In this way, when a part of the floor plan, for example a door, is “clicked on”, a photograph of the egress, for example, appears. In another example, a certain hot spot in the floor plan could bring up a photograph of the building when clicked on. The photograph of the building could, when clicked on, bring up a list of relevant individuals and their contact information. Relationship builder 75 is not limited to a graphical interface. For example, relationship builder 75 could prepare the data for retrieval from a standard electronic relational database. In this case, standard query language could be used by relevant personnel to access information about the building. From time to time, after the initial building data are stored in structure characteristic and relationship database 71, there might be a need to change the data. Information modifier 77 provides this capability, shown here, illustratively but not necessarily, through collector 72. Information modifier 77 manages receiving of changes to the data, re-establishing links among the data, and perhaps storing the data in structure characteristic and relationship database 71.

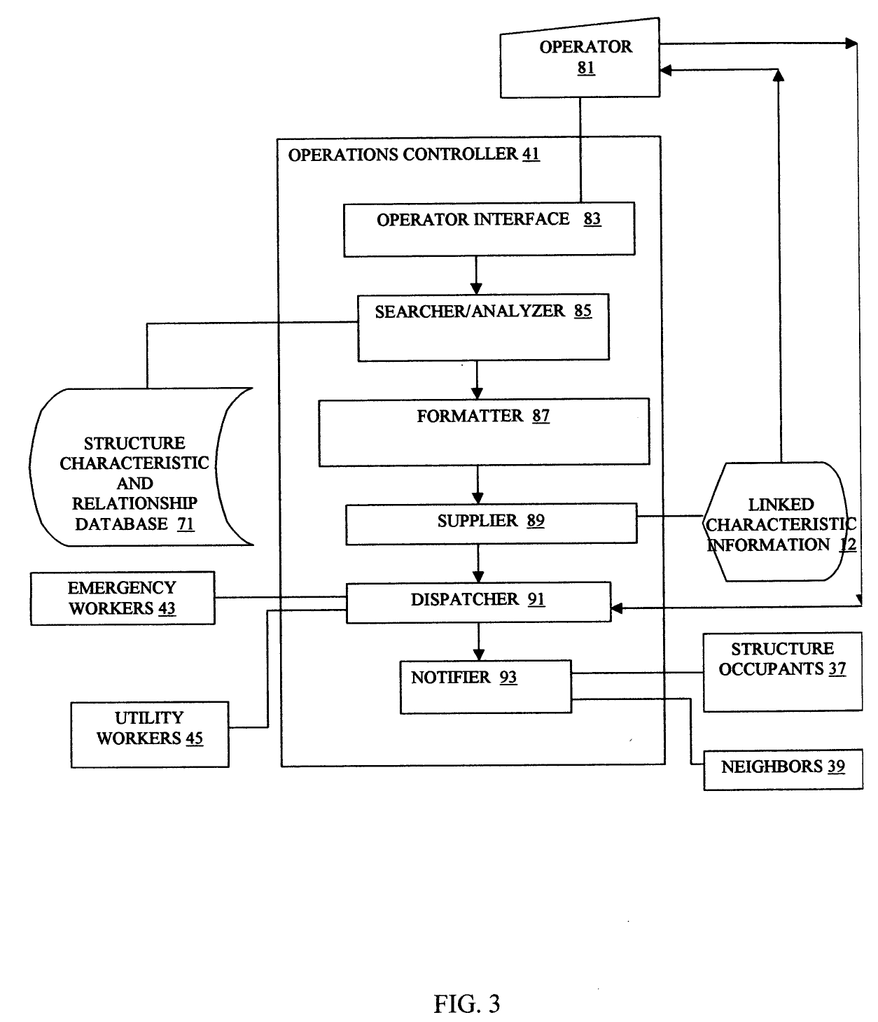

Referring now to FIG. 3, operations controller 41 includes operator interface 83 which provides, for example, a graphical or query interface for operator 81 to access data. Operations controller 41 also includes searcher/analyzer 85 which initiates queries to structure characteristic and relationship database 71 at the request of operator interface 83. Results from the query are prepared in a pre-determined format by formatter 87. The pre-determined format can be, for example, a hard-copy floor plan with appropriate indications based on the other data collected. The pre-determined format can be, for example, an electronic floor plan with hot links to related information. The pre-determined format is not limited to these two examples but can be anything useful to operator 81. Supplier 89 provides linked characteristic information 12 in the pre-determined format to operator 81. If necessary, dispatcher 91 provides instructions to, for example, emergency workers 43, utility workers 45, and notifier 93. Dispatcher 91 can, for example, be invoked by supplier 89 as a result of any analysis performed by searcher/analyzer 85, or can be invoked by operator 81. Notifier 93 can, for example, inform structure occupants 37 and neighbors 39 about any activity related to the building, including a building incident.

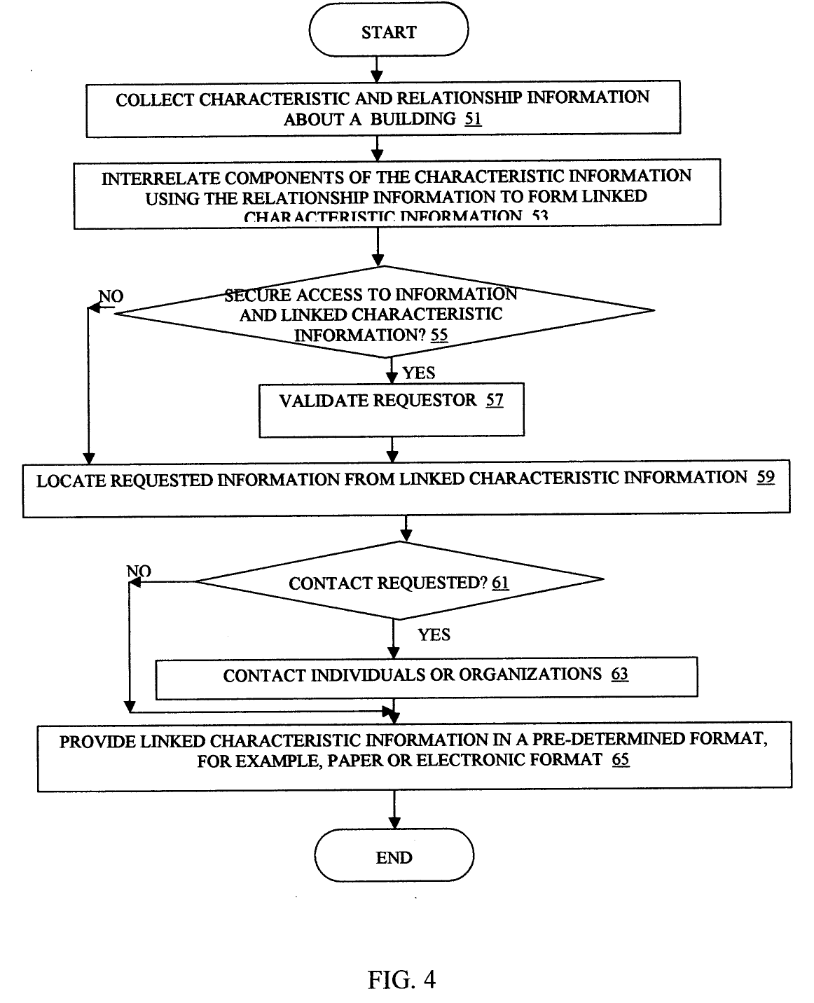

Referring now to FIG. 4, the method of the present invention includes the steps of collecting characteristic and relationship information (method step 51) and interrelating the components of the characteristic information to each other using the relationship information to form linked characteristic information (method step 53). If authentication is required to access linked characteristic information (decision step 55), a data requester is validated (method step 57). In either case, the method includes the step of locating the requested information from the linked characteristic information (method step 59). If the contact information is requested (decision step 61), the method includes the step of retrieving contact information and contacting individuals or organizations (method step 63). The method includes the step of providing the linked characteristic information in a pre-determined format, for example, paper or electronic format (method step 65).

The method of the present invention can be, in whole or in part, implemented electronically. Signals representing actions taken by elements of the system can travel over electronic communications media. Information can be electronically executed and stored on computer-readable media. The system can be implemented to execute on a node in a computer network. Common forms of computer-readable media include, for example, floppy disks, flexible disks, hard disks, magnetic tapes, or any other magnetic media, CDROMs or any other optical media, punched cards, paper tape, or any other physical media with patterns of holes, RAMs, PROMs, EPROMs, FLASH-EPROMs, or any other memory chip or cartridge, carrier waves, smart cards, compact flash cards, flash memory, or any other media from which a computer can read.

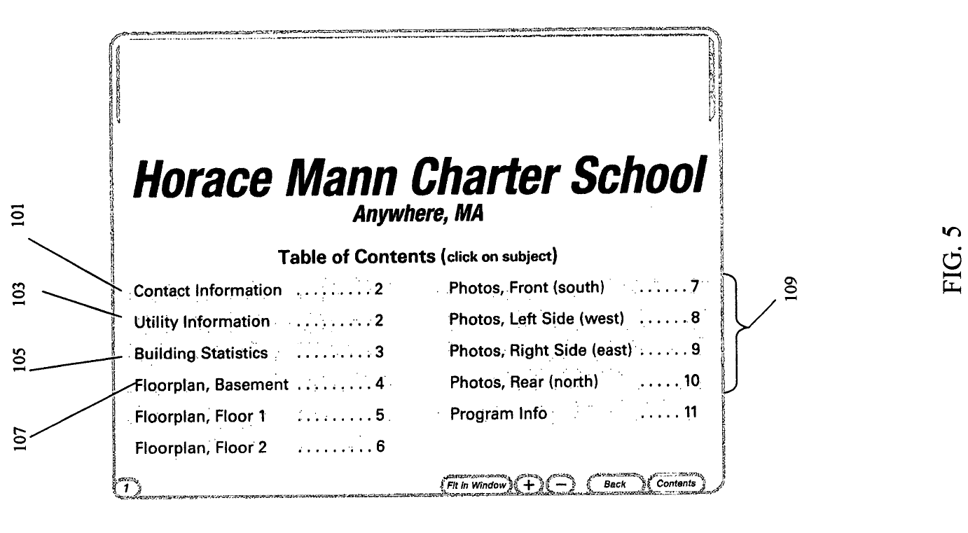

An illustrative embodiment of the graphical aspects of an implementation of the invention is shown in FIGS. 5-9. Referring now to FIG. 5, a possible pre-determined format could include a document containing relevant information about the building. FIG. 5 shows the table of contents for such a document. The document could be in hard-copy form or electronic form, for example, and the table of contents could contain hot links to the sections of the document, for example. The table of contents shown in FIG. 5 includes contact information 101 used for contacting individuals related to the building when necessary as described above. Also included is utility information 103, also described above, which could contain names of the utility companies that service the building such as telephone and electricity providers. The document could contain, for example, building statistics 105 that could include, for example, number of occupants in the building and characteristics of the neighborhood, among other information as previously described. Typically a fundamental aspect of the information about the building is floorplan 107, and perhaps photographs 109.

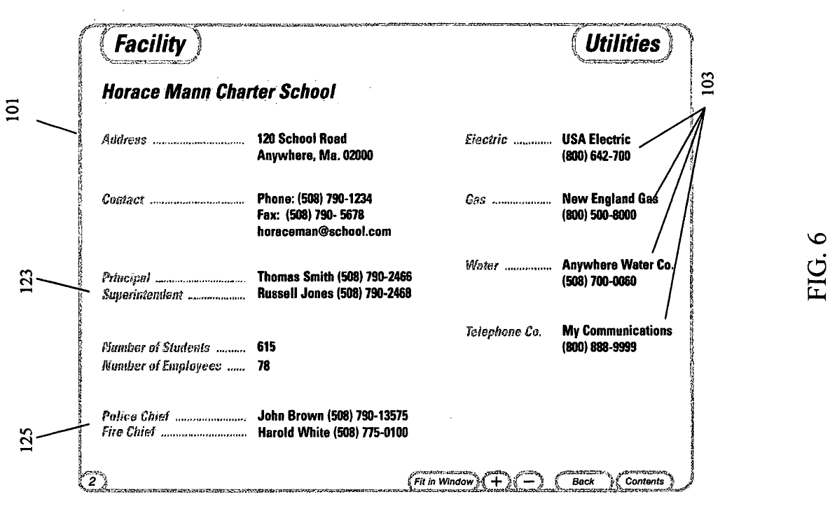

Referring now to FIG. 6, example contact information 101 is provided for possibly relevant (to the building) individuals. In this example, the building is a school, and relevant people could include, for example, superintendent 123 and police chief 125 as well as many others. Utility contact information 103 is shown here to include, for example, electric, gas, water, and telephone phone numbers.

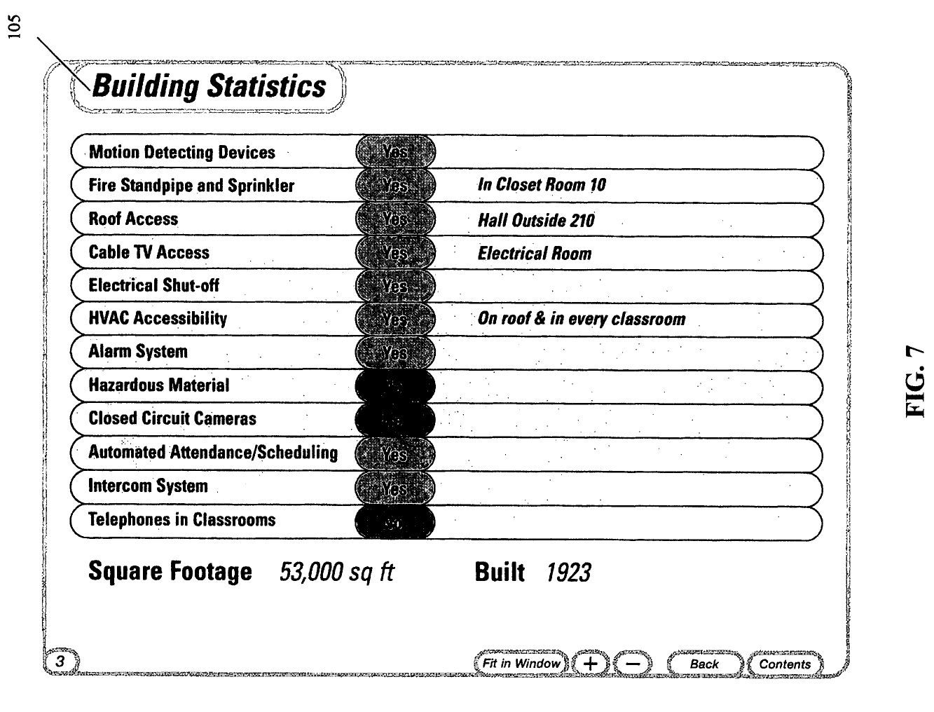

Referring now to FIG. 7, possible building statistics 105 are shown. For example, fire prevention equipment is present in the building and located in a closet room, a photograph of which could be viewed, for example, by clicking on “closet room 10”. Also, its position on the floor plan could be determined in a similar way, should that type of user interface be part of the implementation.

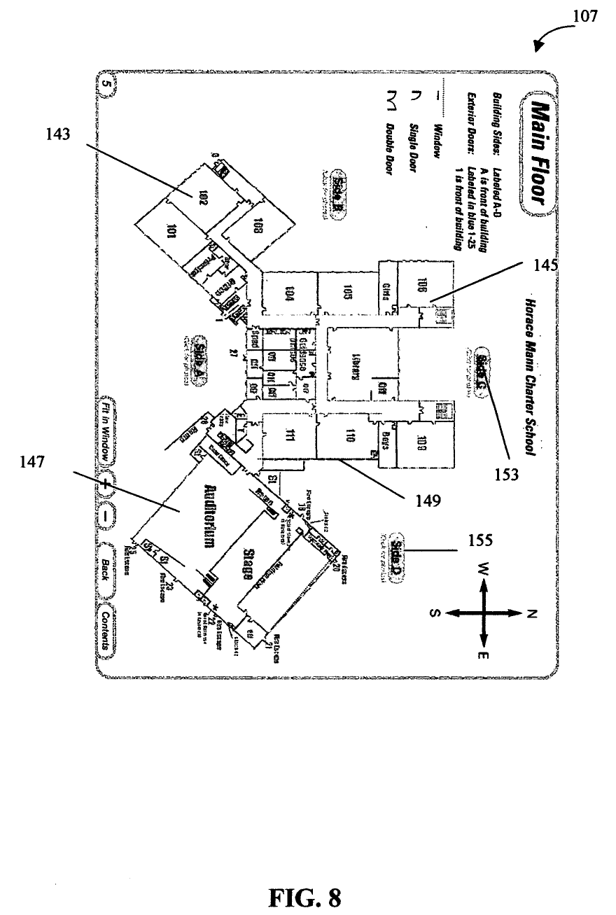

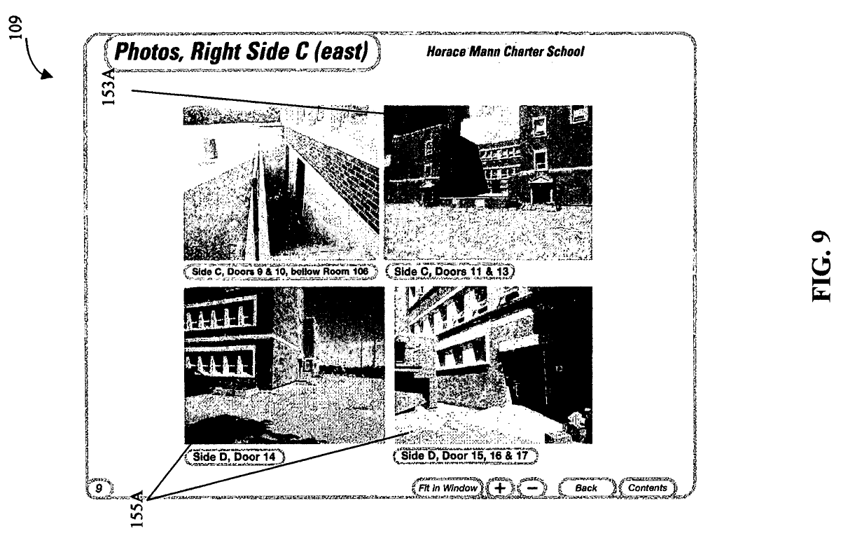

Referring now to FIGS. 8 and 9, floor plan 107 shows links to photographs 109. Side C 153 refers to a side of the illustrative school in the floor plan 107 (FIG. 8), while a side C photograph 153A is shown in FIG. 9. Likewise, side D 155 is shown on the floor plan 107 and in a side D photograph 155A. Other elements of interest in the context of this application include classroom 143, door 145, window 149, and auditorium 147. These are examples of building characteristics and statistics that could be collected during the data gathering process. The location and size of classroom 143 and auditorium 147 could be of great importance when planning evacuations and notifications. Door 145 and window 149 could aid in evacuation of the building.

Although the invention has been described with respect to an illustrative embodiment, it should be realized this invention is also capable of a wide variety of further and other embodiments within the spirit and scope of the appended claims.

1. A method for preparing for and responding to a building incident comprising the steps of:
collecting a plurality of components of characteristic information about a building;
collecting relationship information about the building;
interrelating the plurality of components of the characteristic information through the relationship information to create linked characteristic information; and
providing the linked characteristic information in a pre-determined format.

2. The method as defined in claim 1 further comprising the steps of:
limiting access to the linked characteristic information to a set of users; and
validating that a potential user is a member of the set of users.

3. The method as defined in claim 1 further comprising the steps of:
determining contact information from the linked characteristic information; and
contacting individuals through use of the contact information.

4. The method as defined in claim 3 further comprising the step of automatically contacting individuals through use of electronic contact information.

5. The method as defined in claim 1 further comprising the step of selecting the pre-determined format from a group consisting of electronic format and paper format.

6. The method as defined in claim 5 further comprising the step of selecting the electronic format from a group consisting of a hand-held device, a personal computer, and an electronic network.

7. A system for preparing for and responding to a building incident comprising:
a collector capable of collecting characteristic information and relationship information about a building;
a linkage controller capable of creating links among a plurality of components of said characteristic information through use of said relationship information, said links and said characteristic information forming linked characteristic information; and
an operations controller capable of providing said linked characteristic information in a pre-determined format.

8. The system as defined in claim 7 further comprising an authentication subsystem capable of validating that a potential user is allowed access to said linked characteristic information.

9. The system as defined in claim 7 wherein said characteristic information is selected from a group consisting of building characteristics, utilities list, photographs, demographic information, and emergency response list.

10. The system as defined in claim 7 wherein said linkage controller comprises:
an information collector capable of receiving said characteristic information and said relationship information;
a relationship builder capable of establishing relationships among each of said plurality of components, said relationship builder capable of creating linked characteristic information from said characteristic information and said relationship information; and
an information modifier capable of allowing modification to said characteristic information and said relationship information, said information modifier capable of accessing said relationship builder to recreate said linked characteristic information if necessary.

11. The system as defined in claim 7 wherein said operations controller comprises:
an operator interface capable of receiving requests for said linked characteristic information;
a searcher capable of retrieving the requested said linked characteristic information;
an information formatter capable of preparing the retrieved requested said linked characteristic information in said pre-determined format; and
an information supplier capable of sending said linked characteristic information to a requester.

12. The system as defined in claim 11 wherein said operations controller further comprises:
a dispatcher capable of retrieving a contact list from said linked characteristic information, said contact list including responding contacts and affected contacts, said dispatcher capable of tasking the responding contacts; and
a notifier capable of retrieving said contact list, said notifier capable of informing affected contacts of the building incident.

13. The system as defined in claim 7 further comprising a structure characteristic and relationship database capable of storing information including said characteristic information, said relationship information, and said linked characteristic information.

14. A method for configuring a system for preparing for and managing an incident in a building comprising the steps of:
verifying a floor plan for the building;
photographing pre-determined locations parts of the building;
collecting statistics related to the building;
linking the photographs and the statistics to the floor plan; and
providing the linked information in a pre-determined format.

15. The method as defined in claim 14 further comprising the step of selecting the statistics from a group consisting of number of people in the building, presence of a motion detection system in the building, presence of closed circuit TV in the building, presence of hazardous materials in the building, directions to the building, individuals related to the building, and garages with hazardous material within proximity to the building.

16. The method as defined in claim 14 further comprising the step of selecting the pre-determined format from a group consisting of electronic format and paper format.

17. A node for carrying out the method according to claim 1.

18. A computer readable medium having instructions embodied therein for the practice of the method of claim 1.
